(19) United States
(12) Patent Application Publication
(10) Pub. No.: US 2012/0268240 A1
(43) Pub. Date: Oct. 25, 2012

(54) OPERATING DEVICE FOR OPERATING A MACHINE IN THE FIELD OF AUTOMATION ENGINEERING

(75) Inventor: BJÖRN FRERKING, Nurnberg (DE)

(73) Assignee: Siemens Aktiengesellschaft, Munchen (DE)

(21) Appl. No.: 13/275,824

(22) Filed: Oct. 18, 2011

(30) Foreign Application Priority Data
Oct. 19, 2010 (EP) EP10187981

(51) Int. Cl. G06F 7/04; G06F 3/041

(52) U.S. Cl. 340/5.51; 345/173; 901/46

(57) ABSTRACT

An operating device and a method for operating a machine in automation engineering are disclosed. A touch-sensitive screen detects simultaneous contact with the screen at different positions on the screen, and an external key with a geometric key pattern is provided. A reference pattern is stored in the operating device which compares the geometric pattern determined from the different screen positions detected upon contact of the external key with the screen with the stored reference pattern and allows specific operating actions for operating the machine if the determined geometric pattern matches the stored reference pattern. Authorization to operate a machine can thus be easily ascertained.

### CROSS-REFERENCES TO RELATED APPLICATIONS

This application claims the priority of European Patent Application, Serial No. EP10187981, filed Oct. 19, 2010, pursuant to 35 U.S.C. 119(a)-(d), the content of which is incorporated herein by reference in its entirety as if fully set forth herein.

### BACKGROUND OF THE INVENTION

The present invention relates to an operating device for operating a machine in the field of automation engineering. The invention also relates to a method for recognizing the authorization to operate a machine in the field of automation engineering by means of an operating device.

The following discussion of related art is provided to assist the reader in understanding the advantages of the invention, and is not to be construed as an admission that this related art is prior art to this invention.

Various solutions are currently used to manage operating permissions and unlocking in respect of machines in the field of automation engineering, such as for example machine tools, production machines and/or robots. A simple conventional solution using a key switch is illustrated in FIG. 1. A conventional operating device 1′ for operating a machine in the field of automation engineering includes keys, wherein for the sake clarity only two keys 2′ are denoted by reference signs. Furthermore, the operating device 1′ features a conventional screen 4′ for the purpose of display. For the purpose of recognizing the authorization to operate the machine, the operating device 1′ has a key switch 3′ that unlocks different operating permissions as a function of a conventional mechanical key which is inserted into the key switch 3′ and can be rotated to at most three different positions, for example. A semi-skilled operator only has for example a key which allows the key switch 3′ to be rotated to position 1. When the key switch is rotated to position 1, only certain operating actions for operating the machine are enabled, for example those required for purely routine manufacturing. Further operating actions are not possible in the position 1. A skilled operator such as for example a machine maintenance technician can have for example a key that allows the key switch to be rotated to position 2, whereby further operating actions for operating the machine are enabled by the operating device, for example the installation of new programs. A highly skilled operator such as for example a supervisor can have for example a key (for the key switch 3′) that allows the operator to rotate the key switch 3′ to the position 3, whereby for example all possible operating actions for operating the machine are enabled by the operating device, i.e. unlocked. For example, advanced installation permissions can be approved in the position 3.

Solutions of greater complexity are also known wherein the authorization levels are unlocked by means of transponder/RFID technology.

Disadvantageously, these conventional solutions require additional hardware which when using for example a key switch, allow dirt to enter the interior of the operating device, potentially causing malfunctions of the operating device.

Operating devices for operating a machine in the field of automation engineering employing a so-called multi-touch screen are also known. A multi-touch screen is capable of simultaneously detecting multiple points of contact on a screen, for example from a finger or an object. Multi-touch screens are familiar for example from the iPhone™ produced by Apple®, in which a zoom function is realized, for example, by touching the screen with two fingers (two points of contact).

It would therefore be desirable and advantageous to obviate prior art shortcomings and to provide improved recognition of the authorization to operate a machine in the field of automation engineering.

### SUMMARY OF THE INVENTION

According to one aspect of the present invention, an operating device for operating a machine in the field of automation engineering includes a touch-sensitive screen configured for detecting simultaneous contact with the screen at different positions on the screen, and an external key with a geometric key pattern. The operating device includes a stored reference pattern, and the operating device is configured to compare the geometric pattern determined from the different screen positions detected upon contact of the external key with the screen with the stored reference pattern, thus allowing specific operating actions for operating the machine if the determined geometric pattern matches the stored reference pattern.

According to another aspect of the present invention, a method for recognizing an authorization to operate a machine in the field of automation engineering with an operating device, includes providing a key having a geometric key pattern, contacting with the key a touch-sensitive screen configured for detecting simultaneous contact with the screen at different positions on the screen, comparing the geometric pattern determined from the different screen positions detected upon contact of the external key with the screen with a stored reference pattern stored in the operating device, and allowing specific operating actions for operating the machine if the determined geometric pattern matches the stored reference pattern.

According to one advantageous feature of the present invention, the operating device advantageously compares, when a key comes into contact with the screen, a geometric pattern that is defined by the detected touch locations of the key on the screen with a plurality of stored reference patterns, wherein an authorization level is in each case assigned to the reference patterns, wherein the operating device enables operating actions for operating the machine in accordance with the authorization level assigned to the matching reference pattern if the operating device recognizes a match between the geometric pattern and one of the reference patterns.

Machine tools, production machines and particularly robots often require access protection, so that this invention can be particularly advantageously used with these machines. However, it is obvious that the invention can also be used with other types of machine in the field of automation engineering.

Another advantageous aspect of the invention relates to a computer program comprising program code embodied in a non-volatile storage medium, wherein the computer program when executed on an operating device operating a machine in automation engineering, causes the operating device to detect contact between a key having a geometric key pattern and a touch-sensitive screen configured for detecting simultaneous contact with the screen at different positions on the screen, compare the geometric pattern determined from the different screen positions detected upon contact of the external key with the screen with a stored reference pattern stored in the operating device, and allow specific operating actions for operating the machine if the determined geometric pattern matches one or more stored reference patterns commensurate with an authorization level of the one or more matching stored reference patterns.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic illustration of a conventional operating device for operating a machine in the field of automation engineering,

FIG. 2 shows a schematic illustration of an operating device according to the present invention for operating a machine in the field of automation engineering,

FIG. 3 shows a schematic illustration of a first embodiment of a key,

FIG. 4 shows a schematic illustration of a second embodiment of a key,

FIG. 5 shows a schematic illustration of a third embodiment of a key, and

FIG. 6 shows a geometric pattern being determined.

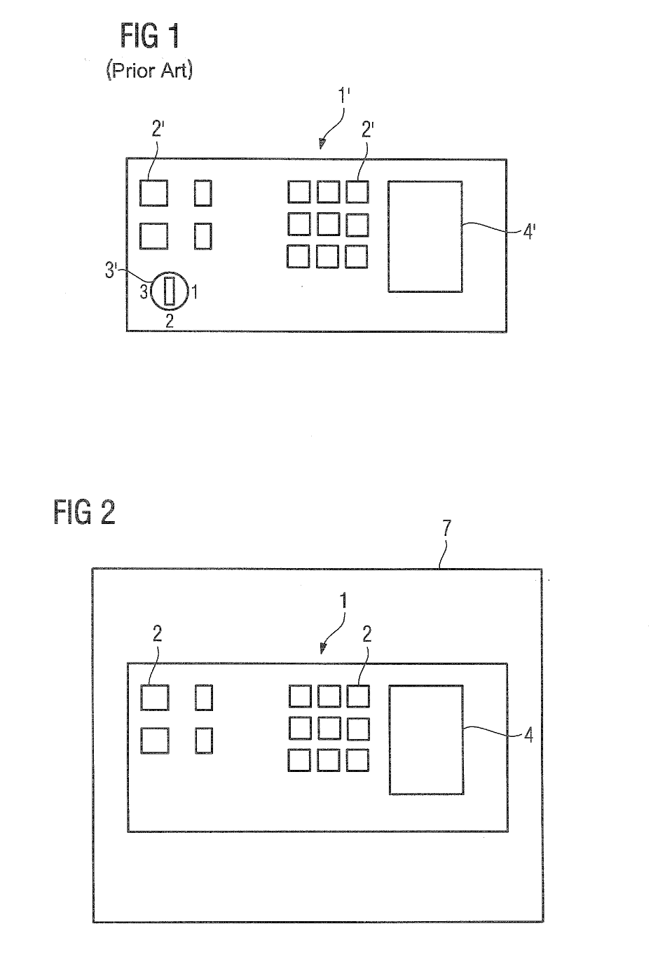

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 2, there is shown an inventive operating device 1 for operating a machine 7 in the field of automation engineering, wherein the machine 7 is illustrated merely schematically in the form of a rectangle. In the context of the exemplary embodiment, the operating device 1 is part of the machine 7 in this case. The operating device has keys for the purpose of operating the machine 7, wherein for the sake clarity only two keys 2 are denoted by reference signs. The operating device 1 for operating the machine 7 also has a so-called multi-touch screen 4. In comparison with normal touch-sensitive screens, multi-touch screens have the characteristic that they can detect at least two simultaneous instances of the screen being touched at different positions on the screen. Such technology is also referred to as “multipoint touch technology”.

The touch locations of at least two instances of the screen being touched, for example, by a finger or by an object at different positions on the screen by can therefore be detected by the touch-sensitive screen 4.

According to the invention, the detection capabilities of a multi-touch screen are used to allow access protection for the operation of the machine in the field of automation engineering.

For this purpose, if a key comes into mechanical contact with the screen, i.e. more precisely if a key comes into mechanical contact with the screen surface, a geometric pattern that is defined by the touch locations of the key on the screen, as detected by the screen, is compared by the operating device 1 with a reference pattern that is stored in the operating device.

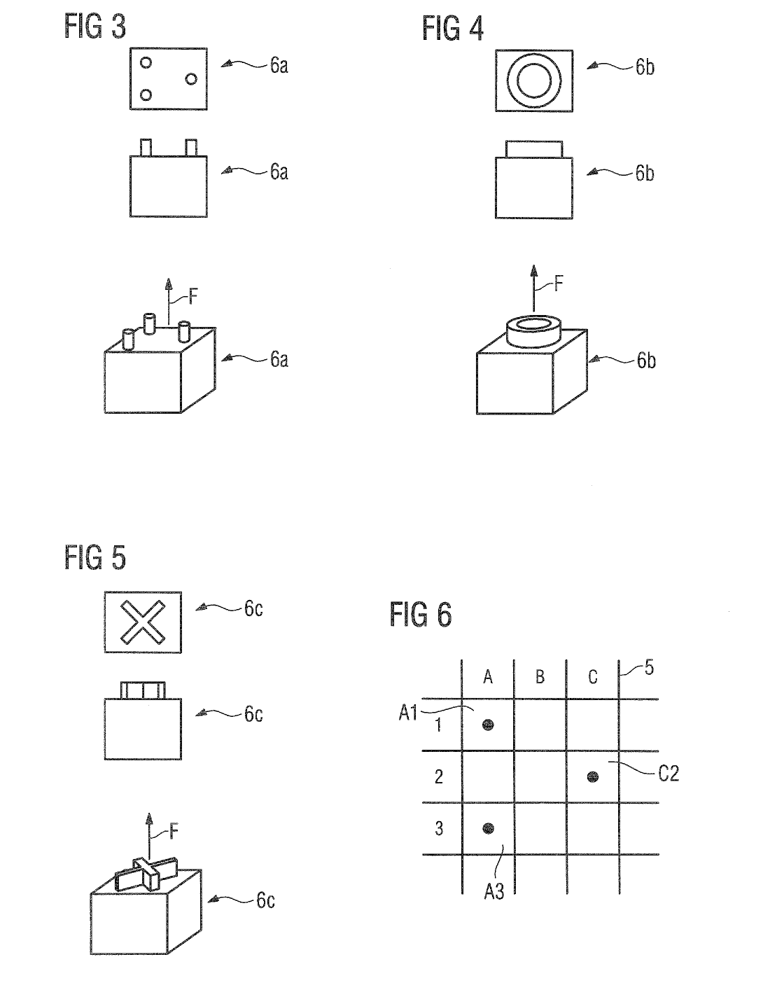

In FIG. 3, FIG. 4 and FIG. 5, three different developments of the key 6a, 6b and 6c are illustrated by way of example, a plan view of the key being shown at the top, a three-dimensional view of the key being shown at the bottom, and a lateral view of the relevant key being shown in the middle in each case. The keys 6a, 6b and 6c can be made of any solid material in this case, and for example stored on a bunch of keys in the same way as a conventional key, for example with the aid of a fastening ring. The key features a geometric shape on at least one side, said shape being used for detection by the multi-touch screen 4. The keys are geometric keys, so to speak. In FIG. 3 the geometric shape that is detected by the screen 4 is realized by means of three projecting pins in this case. The geometric shape of the key is therefore reproduced as a geometric pattern on the multi-touch screen. In FIG. 4 the geometric shape is realized by means of a projecting ring, and in FIG. 5 the geometric shape is realized by means of a projecting cross. Any geometric shape can be used for the keys, wherein the geometric shape of the key is preferably designed such that it cannot be simulated by touching the screen with two fingers simultaneously, and therefore the geometric pattern that is defined by the detected touch locations of the key on the screen cannot be generated by touching the screen with two fingers simultaneously. The geometric pattern is therefore preferably defined by at least three detected touch locations of the key on the screen. The keys effectively resemble stamps.

For the purpose of identifying the operator, the operator pushes the key 6a, 6b or 6c in the direction of the marked arrow F with some force against the screen 4. The geometric shape of the key is consequently detected by the multi-touch screen 4.

The touch locations of the key as detected by the screen 4 form a geometric pattern, which is compared by the operating device 1 with a reference pattern that is stored in the operating device 1. FIG. 6 shows a small section of a detection grid 5 of the screen 4, wherein the columns are numbered as A, B, C and the rows as 1, 2, 3. Fields are formed by the detection grid 5, wherein the multi-touch screen 4 assigns a touch within a field of the detection grid 5 to the corresponding field and hence to a specific location, i.e. to a specific position on the screen surface of the screen. The higher the evaluation precision, i.e. the smaller the fields of the screen, the more complex the geometric shapes of the geometric key can be.

In the simplest case, the geometric pattern that is defined by the detected touch locations can be available in the form of the detected touch locations, and the stored reference pattern can be available in the form of a number of stored touch locations. The geometric pattern that is defined by the detected touch locations of the key on the screen is compared with the stored reference pattern, by comparing the detected touch locations with the stored touch locations. However, such a procedure has the disadvantage that the key for the identification must always be pressed onto the same position on the screen in order to allow identification. Moreover, a rotation of the key would no longer allow identification, because the touch locations change.

It is therefore advantageous for the geometric pattern that is defined by the detected touch locations of the key on the screen to be described for example in the form of relative distances between the detected touch locations, such that it is available in the form of relative distances between the detected touch locations, and for the reference pattern to be available and stored in the form of relative distances between the touch locations accordingly. As part of this evaluation, on the basis of the detected touch locations, the geometric pattern that is defined by the detected touch locations is ascertained by the operating device and is compared with the reference pattern that is stored in the operating device. The geometric pattern that is defined by the detected touch locations of the key on the screen is compared with the stored reference pattern by comparing the ascertained relative distances between the detected touch locations with the stored relative distances between the touch locations. By virtue of this evaluation, the key can be pressed onto the screen 4 at any position and rotated indiscriminately, and nonetheless be correctly recognized by the operating device 1.

The geometric pattern that is defined by the detected touch locations of the key on the screen 4 when using the key 6a as per FIG. 3 is graphically illustrated in FIG. 6. Use of the key 6a therefore results in the geometric pattern that is graphically illustrated in FIG. 6, the touch locations of the key 6a on the screen 4 being represented by large dots in FIG. 6. The key 6a touches the screen 4 in the fields A1, A3 and C2. The geometric pattern that is defined by the detected touch locations, i.e. the fields A1, A3 and C2, is then compared with a reference pattern that is stored in the operating device 1. The geometric pattern is defined by the geometric arrangement of the touch locations.

If the operating device 1 detects a match between the geometric pattern and the reference pattern, specific operating actions for operating the machine 7 are enabled by the operating device. The operating device 1 has a comparison unit for this purpose, which performs the comparison of the geometric pattern with the stored reference pattern and, if there is a match between the geometric pattern and the reference pattern, generates an approval signal.

The previously defined operating actions can be for example safety-related operating actions that must only carried out by an authorized specialist.

Moreover, it is also possible for the operating device 1 to compare the geometric pattern with a plurality of reference patterns that are stored in the operating device, each of the reference patterns being assigned an authorization level. If the operating device recognizes a match between the geometric pattern and one of the reference patterns, operating actions for operating the machine 7 are enabled by the operating device in accordance with the authorization level that is assigned to the matching reference pattern. For example, the key 6a can be assigned the authorization level “1”, the key 6b can be assigned the authorization level “2” and the key 6c can be assigned the authorization level “3”. In this case, for example operating actions that have to be performed during routine production can be enabled in the authorization level “1”. Therefore for example a semi-skilled operator can have the key 6a. For example, additional operating actions such as for example the installation of new manufacturing programs can be enabled in the authorization level “2”. The key that is associated with authorization level 2 can therefore be held by for example a maintenance technician of the machine 7. In the authorization level “3”, for example, all possible operating actions of the machine 7 can be enabled. The authorization level “3” can therefore also include advanced installation permissions, for example. The key 6c, which approves the authorization level “3” in the context of the exemplary embodiment, can be held by a supervisor, for example. The operating actions that are respectively enabled in the authorization levels are assigned to the authorization levels and are stored in the operating device 1.

If the geometric pattern matches the reference pattern, the comparison unit of the operating device 1 generates an approval signal corresponding to the reference pattern.

The two-dimensional geometric shape of a key that is pressed onto the screen is detected by the multi-touch screen 4. If the operating device is already equipped with a multi-touch screen, additional hardware such as for example a mechanical key switch can be omitted as a result of the invention. The enclosed fixed screen surface of a multi-touch screen is moreover generally less sensitive to dirt and wear than a mechanically complicated component such as a key switch, which also has a permanent weak point for the ingress of harmful substances by virtue of its key opening.

It should be noted at this point that the hardware and/or the software of the operating device according to the invention for realizing the functionalities of the operating device does not have to be arranged in a single housing and/or run in a single housing in the case of the software, but can be distributed among various components of the machine 7 in the field of automation engineering, for example the control device (NC, SPC) and/or the regulating device of the machine in the field of automation engineering, and can run in a distributed manner on these components. These components of the machine, for example the control device and/or regulating device, are hereby part of the inventive operating device.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An operating device for operating a machine in automation engineering, comprising:
a touch-sensitive screen configured for detecting simultaneous contact with the screen at different positions on the screen, and
an external key comprising a geometric key pattern,
wherein the operating device comprises a stored reference pattern and the operating device is configured to compare the geometric pattern determined from the different screen positions detected upon contact of the external key with the screen with the stored reference pattern, and to allow specific operating actions for operating the machine if the determined geometric pattern matches the stored reference pattern.

2. The operating device of claim 1, wherein the operating device comprises a plurality of stored reference patterns, with each stored reference pattern having an assigned authorization level, and wherein the operating device is configured to compare the geometric pattern determined from the different screen positions detected upon contact of the external key with the screen with the plurality of stored reference patterns, and to allow, if the determined geometric pattern matches one or more of the stored reference patterns, specific operating actions for operating the machine commensurate with the authorization level of the one or more matching stored reference patterns.

3. The operating device of claim 1, wherein the machine in automation engineering is embodies as at least one of a machine tool, a production machine and a robot.

4. A machine in the field of automation engineering, with an operating device comprising a touch-sensitive screen configured for detecting simultaneous contact with the screen at different positions on the screen, and an external key comprising a geometric key pattern,
wherein the operating device comprises a stored reference pattern and the operating device is configured to compare the geometric pattern determined from the different screen positions detected upon contact of the external key with the screen with the stored reference pattern, and to allow specific operating actions for operating the machine if the determined geometric pattern matches the stored reference pattern.

5. A method for recognizing an authorization to operate a machine in automation engineering with an operating device, comprising:
providing a key having a geometric key pattern,
contacting with the key a touch-sensitive screen configured for detecting simultaneous contact with the screen at different positions on the screen,
comparing the geometric pattern determined from the different screen positions detected upon contact of the external key with the screen with a stored reference pattern stored in the operating device, and
allowing specific operating actions for operating the machine if the determined geometric pattern matches the stored reference pattern.

6. The method of claim 5, wherein the geometric pattern determined from the different screen positions detected upon contact of the external key with the screen are compared with a plurality of stored reference patterns, with each stored reference pattern having an assigned authorization level, and, if the determined geometric pattern matches one or more of the stored reference patterns, specific operating actions for operating the machine commensurate with the authorization level of the one or more matching stored reference patterns are allowed.

7. A computer program comprising program code embodied in a non-volatile storage medium, said computer program when executed on an operating device operating a machine in automation engineering, causing the operating device to
detect contact between a key having a geometric key pattern and a touch-sensitive screen configured for detecting simultaneous contact with the screen at different positions on the screen,
compare the geometric pattern determined from the different screen positions detected upon contact of the external key with the screen with a stored reference pattern stored in the operating device, and
allow specific operating actions for operating the machine if the determined geometric pattern matches the stored reference pattern.
